(19) United States
(12) Patent Application Publication
(10) Pub. No.: US 2006/0179582 A1
(43) Pub. Date: Aug. 17, 2006

(54) Natural aqueous composition and machine for dry-cleaning textiles and leathers

(75) Inventors: Patrick Leschaeve, Hallennes Lez Haubourdin (FR); Christian Eloy, Bois Grenier (FR)

Correspondence Address: LE-NHUNG MCLELAND, 9679-C MAIN STREET, FAIRFAX, VA, 22031-3766, US

(73) Assignee: Teinturerie Leschaeve, Lomme (FR)

(21) Appl. No.: 10/551,762

(22) PCT Filed: Apr. 1, 2004
(86) PCT No.: PCT/FR04/00826

§ 371 Date: Oct. 3, 2005

(30) Foreign Application Priority Data
Apr. 4, 2003 (FR) 03/04249

(51) Int. Cl. B08B 3/12; D06F 43/00; D06L 1/04

(52) U.S. Cl. 8/142; 68/12.08; 68/5 R

(57) ABSTRACT

The present invention relates to an aqueous composition for dry cleaning and/or degreasing textiles and/or leathers, which composition is natural and biodegradable. The dry cleaning composition of the invention comprises in particular essential oils and surface active agents, it is etherizable and micronizable, and its ingredients are exclusively of vegetable origin. The invention also relates to a method of dry cleaning and/or degreasing textiles and/or leathers implementing the above-described aqueous composition, the method comprising a succession of stages of tumbling the textiles and/or leathers in a leaktight enclosure, wherein one of the stages consists in impregnating the textiles and/or leathers with a small quantity of an aqueous composition by means of pneumatic atomization at a size no more than 50 μm, for a limited duration, and at a temperature of about 35° to 45° C., until the total weight gain is about 5% to 70%. The invention also relates to a machine for dry cleaning and/or degreasing textiles and/or leathers by implementing said method.

The present invention relates to the field of dry cleaning textiles and leathers.

### BACKGROUND OF THE INVENTION

Dry cleaning makes it possible to clean textiles (garments and furnishing fabrics) that are unsuitable for washing in water. This applies to leather, fabrics that are thick, plush, or that crumple easily, such as, for example coats, trousers, suits; certain skins; wool textiles that can become felted; and certain categories of garments or furnishing fabrics that present fragile stitching and thermofusing that can move, as stated in the care label. Dry cleaning is carried out by professionals, under precisely regulated technical conditions and in compliance with various obligations to the consumer.

Dry cleaning professionals have high-performance machines circulating a cleaning solvent around a closed circuit. Prior art dry cleaning machines comprise an enclosure containing a drum holding textile articles for cleaning, the drum operating in continuous or back-and-forth rotation, and said solvent being introduced into said enclosure.

The solvent in most widespread use throughout the world is perchlorethylene, which presents the advantage of being highly effective in dissolving spots and dirt (grease, fats) on garments. Nevertheless, the use of perchlorethylene raises numerous problems associated with the environment (destroying the ozone layer, polluting ground water), with human health (the presence of carcinogenic substances), and with user safety.

The increasing preoccupation of public authorities concerning the possibly harmful effects of perchlorethylene on human health has led recently to the European Union adopting a Directive (2001/59/EC) deciding to replace the heading specifying risk R40 “possible irreversible effects” with “limited evidence of a carcinogenic effect”. This amendment is to appear in material safety data sheets (MSDS) and on the labels of packaging.

Alternative dry cleaning methods have been proposed, comprising in particular the use of:

solvents based on hydrocarbons;

aqueous formulations; and

semi-aqueous systems.

Nevertheless, such alternative methods themselves also present disadvantages. Thus, solvents based on hydrocarbons can catch fire. Their consequences on human health have not yet been sufficiently investigated. Furthermore, aqueous formulations generate large quantities of contaminated water that must then be treated.

An acceptable solution would be to use aqueous dry cleaning formulations that are natural and biodegradable.

Such formulations, that preserve the environment, have already been proposed. U.S. Pat. No. 6,136,778 describes an aqueous detergent composition comprising one or more detergents selected from the group comprising essential oils and essential oil ingredients that have been isolated from such oils or synthesized, a surface active agent, and an enzyme. Nevertheless, the detergent composition described is exclusively for home use and not for industrial scale dry cleaning.

### OBJECTS AND SUMMARY OF THE INVENTION

In a first aspect, the object of the present invention is to propose an aqueous dry cleaning and/or degreasing composition for textiles and leathers that is natural and biodegradable, while retaining excellent cleaning properties.

In a second aspect, the invention relates to a dry cleaning machine implementing said method.

In a third aspect, the invention concerns a method of dry cleaning and/or degreasing textiles and leathers implementing said composition.

In its first aspect, the object of the invention is fully achieved by means of the aqueous dry cleaning and/or degreasing composition for textiles and leathers, preferably prepared from a concentrate, comprising in particular an essential oil and a surface active agent, the composition being etherizable and micronizable to smaller than 50 micrometers (μm), and the ingredients of the composition being exclusively of vegetable origin.

The term “micronizable” is used in the context of the present invention to mean the property whereby a liquid can be reduced into fine particles by spraying, in particular by pneumatic atomization. The term “pneumatic atomization” means spraying a liquid by devices known as automatic pneumatic atomizers that mix air and the liquid for spraying so as to give a jet that is fully atomized. The term “etherizable” is used in the context of the present invention to mean the quality whereby a compound is highly volatile. As a result, the composition of the invention—when it is micronized—presents very high ability to penetrate into textiles and to disperse, which ability is close to that of a solvent, thereby achieving dry cleaning.

The composition of the invention presents the following characteristics: micronizable to smaller than 50 μm, high cleaning power, detergent, degreasing, softening, antiseptic, regenerating, perfuming, and adaptable to variations in temperature and pressure.

Said composition comprises extracts from plants (leaves, flowers, fruits, seeds, roots), trees (bark), legumes, cereals, and marine plants (seaweed). Consequently, the composition of the invention is 100% natural (no toxic effects on human health), 100% biodegradable (no harmful effects on the environment), and it does not catch fire (no risk for user safety).

The aqueous cleaning and/or degreasing composition of the invention comprises at least one essential oil and at least one surface active washing agent suitable for making essential oils soluble in water.

In preferred manner, said essential oil is selected from the group comprising the essential oils of: Cymbopogon; Mentha piperata; Eucalyptus citriodora; Eugenia; and Citrus limonum. Said surface active agent is preferably selected from the group comprising: extracts of wheat, soy bean, palm, cocoa, coprah, olive, fucus.

For an aqueous dry cleaning and/or degreasing composition that is preferably prepared from a concentrate, said concentrate, in a variant embodiment, comprises:

at least 100% pure and natural essential oil representing 0.5% to 10% by weight; and

at least one detergent and emulsifying surface active agent that is exclusively of vegetable origin, that is well tolerated by the skin, and that represents 5% to 20% by weight.

In a variant embodiment, it further comprises:

at least one compound such as oils, vegetable glycerin, and floral waters, representing 5% to 90% by weight;

at least one fruit alcohol, tree gum, and natural wax representing 0.5% to 30% by weight;

at least one additive having one or more of the following properties: humectant, antistatic, antioxidant, antibacterial, sanitizing, fluidifying, softening, bulking, and preserving, representing 0.1% to 10% by weight; and

at least one enzymatic compound and/or salt representing 0.05% to 10 by weight.

It may also comprise other molecules of vegetable origin that are not included in the above-specified categories, having properties that improve the process of dry cleaning by pneumatic atomization.

The cleaning and/or degreasing qualities of the aqueous composition are due in particular to the presence of the essential oils and the surface active agents, which serve to make the essential oils soluble in water. The essential oils are capable of quickly dissolving fats and liquid or solid polymers. Their cleaning capacity is increased in the presence of enzymes: the emulsifying action of essential oils facilitates contact between enzymes and liquefied fats, and, consequently, facilitates the degradation action of the enzyme. In order to ensure good cleaning activity for the enzymes present in the cleaning composition of the invention, its pH should be maintained in the range 6 to 8.

The above-described concentrate does not contain:

genetically modified organisms or derivatives of genetically modified organisms;

ingredients exposed to ionizing radiation;

ingredients subjected to the ethoxylation process;

ingredients containing ethylenediamine tetraacetic acid (EDTA);

ingredients of animal origin;

petrochemical ingredients; and

organophosphate ingredients.

In a second aspect, the invention provides a machine for dry cleaning textiles and leathers by implementing said method. The dry cleaning machine of the invention comprises: a drum mounted in an enclosure that is closed by a door in leaktight manner; heater means; suction means; filter means; and control means. In characteristic manner, the machine has pneumatic atomization means suitable for spraying droplets of the above-described aqueous composition and of size no greater than 50 μm into the inside of the enclosure for a limited duration, and at a temperature less than or equal to 45° C., until the garment has taken up a small amount of extra weight, of the order of 5% to 70%.

In a third aspect, the invention relates to a method of dry cleaning and/or degreasing textiles and/or leathers implementing the above-described aqueous composition. In characteristic manner, the method comprises a succession of stages of tumbling the textiles and/or leathers in an enclosure, including a stage which consists in impregnating the textiles and/or leathers with a small quantity of an aqueous composition by pneumatic atomization to a size no greater than 50 μm for a limited duration and at a temperature less than or equal to 45° C., until there is a small gain in weight, preferably of the order of 5% to 70%.

Preferably, the weight gain of the garments lies in the range 5% to 40%.

The cleaning method of the invention can be categorized as a dry cleaning method because:

the washing composition used is an etherizable and micronizable solution having high conductivity, close to that of a solvent; and

the weight gain of the garments during washing is limited to 70%, whereas in water cleaning methods, garments increase in weight by at least 100% during washing.

### BRIEF DESCRIPTION OF THE DRAWINGS

The cleaning concept on which the described dry cleaning method is based, and the operation of the dry cleaning machine implementing the method can be better understood on reading the following description made with reference to the accompanying drawings, in which:

FIG. 1 is a diagrammatic cross-section view of a dry cleaning machine for implementing said method;

FIG. 2 is a diagrammatic longitudinal section (FIG. 2A) and cross-section (FIG. 2B) of the door of the dry cleaning machine fitted with an atomization nozzle;

FIG. 3 shows the circuit for feeding the pneumatic atomization nozzle installed on the door of the machine;

FIG. 4 is a diagram of additional elements of the dry cleaning machine; and

FIG. 5 shows the main steps in the dry cleaning method of the invention, in schematic form.

### MORE DETAILED DESCRIPTION

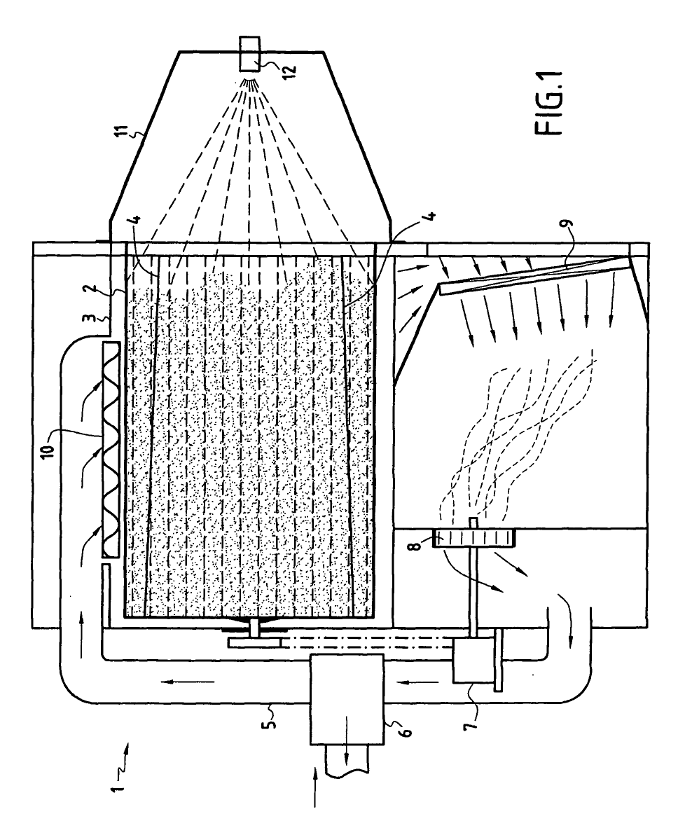

With reference to FIG. 1, the dry cleaning machine 1 in accordance with the invention for cleaning textiles and leathers—referred to below as “articles”—comprises a stainless steel drum 2 without a shaft, and pierced to 50%. The drum 2 is mounted on wheels causing it to turn back and forth inside a totally leaktight enclosure 3, and it is provided with a plurality of beaters 4, preferably four beaters, for lifting items being rotated back and forth.

The dry cleaning machine 1 also comprises the following elements:

a closed-circuit ventilation circuit 5 provided with a bypass device 6 for opening or closing said ventilation circuit on command;

a motor 7 driving a suction turbine 8;

a filter 9;

an electrical resistance element 10; and

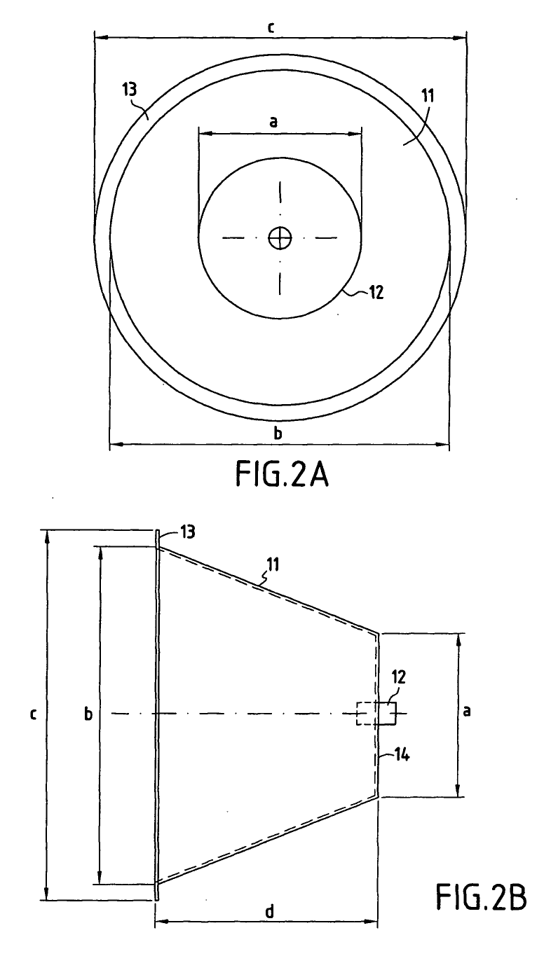

a door 11 facing the drum 2 for use when loading textiles and/or leathers for cleaning (FIG. 2) and for unloading them after cleaning.

The door 11 is frustoconical in shape, projecting out from the enclosure 3, and is provided with a pneumatic atomization nozzle 12 of caliber that is a function of the volume of air inside the machine. The beaters extend longitudinally and project radially towards the inside of the drum. In the example shown they are constituted by plates in the form of right trapezoids having a top face that slopes downwards away from the door towards the opposite end of the enclosure. This disposition encourages penetration of the washing composition and ensures that the articles moving in front of the nozzle are tumbled uniformly. Thus, inside the drum, the articles are caused to move with two different types of movement: circularly—about the axis of rotation of the drum—and longitudinally.

As shown in FIG. 2, the door 11 is built in the form of a truncated cone, being characterized by:

an annular rim 13 of inside diameter b and outside diameter c, for pressing in leaktight manner against the outline of the opening for closing the enclosure;

a flat end wall 14 of diameter a; and

an axial extent d.

The nozzle 12 is mounted centrally in the end wall 14 corresponding to the smaller portion of the truncated cone. It is thus situated at a distance d from the enclosure 3 that is determined in such a manner as to obtain spray throughout the section of the drum as soon as the spray enters into the drum level with the rim 13.

In a preferred embodiment of the invention, these parameters have the following values:

a=220 millimeters (mm);

b=460 mm;

c=510 mm; and

d=300 mm;

the hole in the door 11 corresponding to the nozzle 12 being 30 mm.

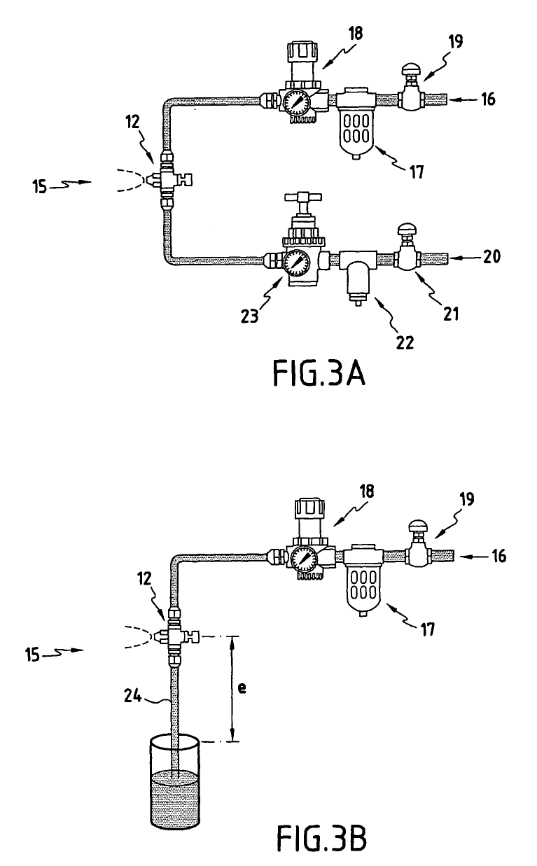

As shown in FIG. 3, which shows the circuit 15 for feeding the atomization nozzle 12, the air enters the circuit via an air inlet 16, and then passes through a filter 17. Its pressure is adjusted by means of a regulator 18. The flow of air in the circuit is controlled by a stop cock 19.

In a variant embodiment as shown in FIG. 3A, there is an inlet 20 for the liquid to be sprayed (washing composition) that is under the control of a cock 21. After passing through a filter 22, said liquid reaches the nozzle 12 under a pressure that is maintained at a value in the range 0.7 bars to 4 bars by a regulator 23. The air and said liquid can be mixed either internally or else externally in order to give a fully atomized jet. In another variant embodiment, shown in FIG. 3B, the liquid for spraying (washing composition) is brought to the nozzle 12 by siphoning (siphoning height e) or by gravity. The liquid is sucked into a feed pipe 24 and then mixed with air, and finally it is atomized.

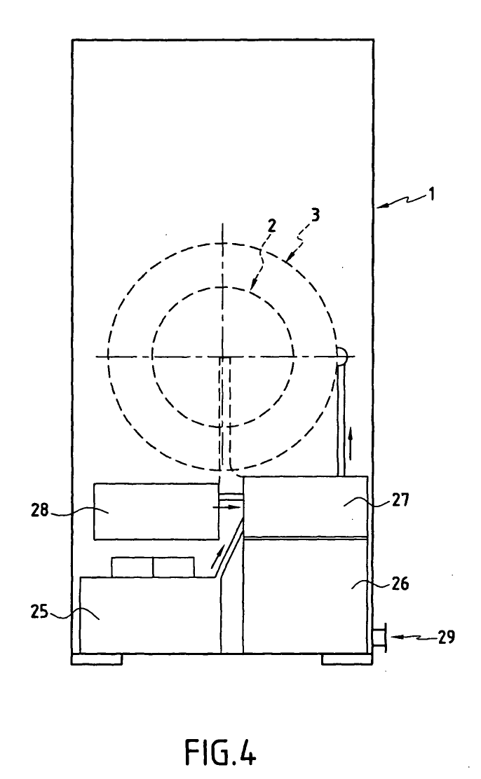

The cleaning machine is also fitted with the following equipment (FIG. 4): a water recovery tank; a condenser; a filter space (these items not shown); a compressor 25 with a 30-liter (L) tank, having a minimum pressure of 6 bars for feeding the nozzle 12; a water softener 26; a metering pump 27; and a tank 28 for the cleaning concentrate (FIG. 4), together with a refrigerator unit and supplies of hot water at 30° C. to 80° C. (a coil), and for preparations (these items not shown).

Filtering remains constant from the beginning to the end of the cleaning cycle, and also throughout the drying stage.

In order to operate, the above-described dry cleaning machine requires merely a water supply 29 and an electricity outlet. The controls of the machine are to be found on its front face. All of the elements of the machine that come into contact with the washing composition are made of stainless steel, with the gasket being made of Teflon.

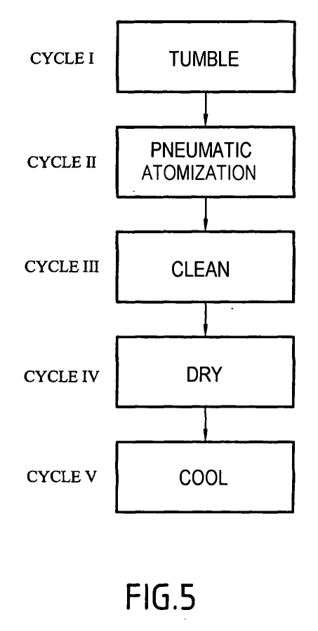

The method of the invention for dry cleaning and/or degreasing textile and/or leather articles comprises the following main stages (cycles) as shown in FIG. 5:

Cycle I: Tumbling Stage:

placement of the articles in the drum 2 of the machine;

airing and tumbling the articles by the drum 2 moving in rotation (back and forth);

ventilation with progressive heating up to 40° C.;

ventilation circuit 5 open-circuit; and

duration in the range 5 minutes (min) to 15 min.

Cycle II: Pneumatic Atomization Stage:

closure of the ventilation circuit 5;

interruption of ventilation and heating;

tumbling maintained;

temperature maintained at about 40° C.;

pneumatically atomizing the washing composition with a particle size of no more than 50 μm into the drum 2 at the requested moisture setting; and

duration in the range 5 min to 15 min.

Cycle III: Cleaning Stage:

pneumatic atomization;

ventilation;

ventilation circuit 5 kept closed-circuit;

duration in the range 10 min to 20 min; and

temperature maintained at about 40° C.

Cycle IV: Drying Stage:

ventilation circuit 5 open-circuit;

ventilation;

duration in the range 10 min to 20 min; and

temperature maintained in the range 30° C. to 45° C.

Cycle V: Cooling Stage:

heating switched off, temperature lowered to a programmed temperature;

ventilation; and

duration in the range 5 min to 10 min.

In a preferred embodiment, the cleaning method of the invention also includes a pre-spotting step. A pre-spotter can be used: in the machine, on a spot-remover table; on a dummy.

Stages IV and V are brought to an end by using a moisture detector.

The following non-limiting implementations illustrate in greater detail the above-described method of the invention for dry cleaning and/or degreasing textiles and/or leathers, and also the operation of the machine implementing said method.

### EXAMPLE 1

The method of the invention comprises the following steps:

i) Filling the machine with 5 kilograms (kg) to 90 kg of articles—textiles and/or leathers—via the door 9, and then closing the door 9; selecting a program; initiating the program (locking the door); starting.

ii) The articles are put into place and aired by the drum rotating back and forth; this tumbling which corresponds to cycle I opens up the textiles and/or leathers and de-dusts them, with the coarsest dust particles being eliminated; duration is in the range 5 min to 10 min, and operation takes place with ventilation switched on (with progressive heating); the circuit 5 is open-circuit.

iii) The circuit is closed so that the drum 2 becomes totally leaktight; ventilation is stopped; heating is maintained at about 40° C.

iv) Particles of the washing composition having a maximum size of 50 μm are pneumatically atomized into the drum 2 via the nozzle 12; the concentration of the washing composition lies in the range 5% to 20% of the described cleaning concentrate; duration lies in the range 5 min to 15 min depending on the requested moisture setting; temperature of about 40° C. (essential oils are more volatile at this temperature, thereby achieving better penetration into garments and thus higher quality cleaning). The water+concentrate moisture level (in the range 5% to 70%) relative to the weight of articles varies depending on the composition of the fibers: wool, cotton, or synthetic. Pneumatic atomization of the concentrate, corresponding to cycle II, leads to the garments increasing in weight by about 5% to 70%.

In a preferred implementation, the increase in weight of the garments lies in the range 5% to 40%.

v) The heater unit 10 is started and temperature is maintained at about 40° C.; ventilation (tumbling) as in cycle III serves to maintain uniform circulation of heat over the articles that have absorbed the substance in this confined and sealed medium; duration lies in the range about 10 min to 20 min, depending on the textiles and/or leathers to be treated (see possible programs).

vi) The circuit 5 is opened, ventilation is maintained for a duration lying in the range 10 min to 20 min; and the temperature of the circuit is maintained at about 40° C. for drying as in cycle IV.

vii) The heater unit 10 is switched off and the articles cooled as in cycle V; duration lying in the range 5 min to 10 min depending on the program.

viii) The drum 2 is stopped (desired level of cooling reached); the door 11 is released (flashing signal).

The back-and-forth rotation of the drum 2 is generally constant from the beginning to the end of the program. The direction of rotation of the drum 2 can be reversed every 30 seconds, for example. Continuous filtering (from the beginning to the end of the requested program) takes place in a completely closed circuit. The dry cleaning machine operates in a closed circuit by condensation.

### EXAMPLE 2

Dry Cleaning Test

| General information | | |
|---|---|---|
| Material of the various | Wool/viscose/cotton/mixed | |
| articles | fibers | |
| Material weight | 4 | kg |
| Total duration | 50 | min |
| Moisture content | 30% | |
| Volume of water/concentrate | 1.2 L + 0.1 L = 1.3 L | |
| (aqueous solution) | | |
| % concentrate | 7.7% | |
| 1 - Tumbling stage | | |
| Tumbling time | 5 | min |
| Inside air temp. at 5 min | 37° | C. |
| Solution temp. | 20° | C. |
| pH | 6.5 | |
| 2 - Pneumatic atomization | | |
| stage | | |
| Spray time | 10 | min |
| Start inside temp. | 31° | C. |
| Inside temp. at 5 min | 29° | C. |
| Inside temp. at 10 min | 27° | C. |
| Air pressure | 1.3 | |
| Liquid pressure | 0.7 | |
| Flow rate L/h | 12.5 | |
| pH at 1 min | 7.22 | |
| 4 - Cleaning stage | | |
| Cleaning time | 15 | min |
| Start inside temp. | 37.5° | C. |
| Inside temp. at 6 min | 38.7° | C. |
| Inside temp. at 15 min | 36° | C. |

| pH at 15 min | 6.95 | |
|---|---|---|
| 5 - Drying stage | | |
| Drying time | 15 | min |
| Inside temp. | 36.6° | C. |
| Inside temp. at 10 min | 38° | C. |
| pH at 1 min | 7.25 | |
| 6 - Cooling stage | | |
| Cooling time | 5 | min |
| Material temp. | 27° | C. |

| | |
|---|---|
| Moisture content | OK for ironing |

The moisture detector triggers the end of hot drying and also the overall end of the process.

[NB.: moisture is monitored continuously in stage 4.

Analysis of Results

Broadcloth wool jacket: rumpled, thermofused, dimensions unchanged, no felting.

Impeccable Chanel wool jacket.

Impeccable viscose dress, striking, state as though ironed.

Wool jacket of impeccable quality.

State of residues: dry, clean fibers, no particular odor.

Other tests, carried out on articles comprising wool mixtures, polyester, 100% cotton, gave the following results:

on a pale cotton jacket, having a very dirty collar, dirt was found to disappear except for an encrustation due to wear from the wearer;

on a collar of leather in poor state, the cleaned leather was observed to have remained flexible and was not depigmented; and

on a wool jacket, the thermofused pieces did not move.

Articles cleaned using the dry cleaning method described above are more flexible, less faded, and present an odor that is slight and agreeable.

The advantages obtained by using the above-described method of dry cleaning and/or degreasing textiles and/or leather are multiple:

replacement of perchlorethylene, and thus no risk for the environment or for the health and safety of users;

elimination of the step of soaking garments;

textiles impregnated with a small (measured) quantity of a washing composition by micro-spraying;

no degradation of fibers;

no degradation of thermofused pieces; and

no shrinking or felting of articles, including PVC yokes or linings, coatings and mixtures of various different coatings, . . . .

What is claimed is:

1. An aqueous composition for dry cleaning and/or degreasing textiles and/or leathers, the composition comprising in particular essential oils and surface active agents, the composition being etherizable and micronizable to less than 50 μm, and the ingredients of the composition being exclusively of vegetable origin.

2. An aqueous dry cleaning composition according to claim 1, including at least one entirely pure and natural essential oil selected from the group comprising the essential oils of: Cymbopogon, Mentha piperata, Eucalyptus citriodora, Eugenia, Citrus limonum.

3. An aqueous dry cleaning composition according to claim 1, including at least one surface active agent of exclusively vegetable origin, well-tolerated by the skin, selected from the group comprising: extracts of wheat, soy bean, palm, cocoa, coprah, olive, fucus.

4. An aqueous dry cleaning composition according to claim 1, including at least one component such as: oils, vegetable glycerin, and floral waters.

5. An aqueous dry cleaning composition according to claim 1, including at least one fruit alcohol, tree gum, and natural wax.

6. An aqueous dry cleaning composition according to claim 1, including at least one additive having one or more of the following properties: humectant, antistatic, antioxidant, antibacterial, sanitizing, fluidifying, softening, bulking, and preserving.

7. An aqueous dry cleaning composition according to claim 1, including enzymatic compounds and/or salts.

8. An aqueous dry cleaning composition according to claim 1, having pH lying in the range 6 to 8.

9. An aqueous dry cleaning composition according to claim 1, prepared from a concentrate, wherein said concentrate preferably comprises:
a) at least 100% pure and natural essential oil representing 0.5% to 10% by weight;
b) at least one detergent and emulsifying surface active agent of exclusively vegetable origin, that is well tolerated by the skin, representing 5% to 20% by weight;
c) at least one ingredient such as oils, vegetable glycerin, and floral waters, representing 5% to 90% by weight;
d) at least one fruit alcohol, tree gum, and natural wax representing 0.5% to 30% by weight;
e) at least one additive having one or more of the following properties: humectant, antistatic, antioxidant, antibacterial, sanitizing, fluidifying, softening, bulking, brightening, and preserving, representing 0.1% to 10% by weight; and
f) at least one enzymatic compound and/or salt representing 0.05% to 10.

10. A method of dry cleaning and/or degreasing textiles and/or leathers, the method comprising a succession of stages of tumbling the textiles and/or leathers in a leaktight enclosure, wherein one of the stages consists in impregnating the textiles and/or leathers with a small quantity of an aqueous composition according to claim 1, by pneumatic atomization to no more than 50 μm, for a limited duration, and at a temperature less than or equal to 45° C., until there is a weight gain of about 5% to 70%.

11. A dry cleaning method according to claim 10, comprising the following stages: tumbling; pneumatic atomization of the washing aqueous composition; cleaning; drying; cooling.

12. A method according to claim 10, wherein the weight gain of the garments lies in the range 5% to 40%.

13. A machine for dry cleaning textiles and leathers, the machine comprising: a drum provided with beaters mounted in a leaktight enclosure; heater means; suction means; filter means; control means; and a door, the machine including means for producing within the enclosure pneumatic atomization at no more than 50 μm of a washing aqueous composition according to claim 1 during a limited period of time, and at a temperature less than or equal to 45° C., until the garments have gained about 5% to 70% in weight.

14. A dry cleaning machine according to claim 7, wherein the drum is in rotation, changing direction in alternation from the beginning to the end of the program.

15. A dry cleaning machine according to claim 13, wherein the direction of rotation of the drum is reversed every 30 seconds.

16. A cleaning machine according to claim 13, wherein filtering takes place continuously and in a closed circuit from the beginning to the end of the program.

17. A cleaning machine according to claim 13, wherein the beaters are disposed obliquely flaring apart away from the nozzle.

18. A cleaning machine according to claim 13, wherein the door is provided with a single pneumatic atomization nozzle situated in the central portion of the door.

19. A cleaning machine according to claim 13, wherein the door is of frustoconical shape, projecting outwards from the enclosure such that the nozzle is situated at a distance d from the enclosure.
